(19) United States
(12) Patent Application Publication
(10) Pub. No.: US 2011/0248866 A1
(43) Pub. Date: Oct. 13, 2011

(54) Communication System And Method

(75) Inventors: Richard J. Chutorash, Oakland Township, MI (US); James E. Trainor, Holland, MI (US); Jeffrey Golden, Holland, MI (US); Steven L. Geerlings, Holland, MI (US)

(73) Assignee: JOHNSON CONTROLS TECHNOLOGY COMPANY, Holland, MI (US)

(21) Appl. No.: 13/123,010

(22) PCT Filed: Oct. 13, 2009
(86) PCT No.: PCT/US2009/060465

§ 371 Date: Jun. 21, 2011

Related U.S. Application Data
(60) Provisional application No. 61/104,847, filed on Oct. 13, 2008.

(51) Int. Cl. G08G 1/00; B60Q 1/00; H04B 7/00

(52) U.S. Cl. 340/901; 455/66.1; 340/425.5

(57) ABSTRACT

The invention relates to a communication system and a communication method, the communication system comprises a first communication module (11) and a second communication module (12). The first communication module (11) is located inside a vehicle (1), and the second communication module (12) is located in a Garage Door Opener (3) and/or a home (2). A first information (11) relating to status information of the vehicle (1) is transmitted wirelessly between the first and second communication modules (11, 12). Additionally or alternatively, a second information is transmitted between the first and second communication modules (11, 12). The second information relates to status information of the Garage Door Opener (3) and/or the home (2).

### CROSS REFERENCE TO RELATED APPLICATION

The present application claims the benefit of PCT International Application No. PCT/US2009/060465 filed Oct. 13, 2009, entitled “Communication System And Method” and U.S. Provisional Application Ser. No. 61/104,847 filed Oct. 13, 2008, entitled “Vehicle Exclusive Use 2-Way Communication Scenarios”, and the disclosures of these applications are incorporated herein by reference in their entirety.

### BACKGROUND OF THE INVENTION

The present invention relates to a method that allows 1-way, or preferably 2-way, communication (unidirectional or bidirectional communication) between a first communication module within a vehicle and a second communication module within, for example, a Garage Door Opener (GDO) and/or a home. The present invention also relates to a vehicle and a home-system for allowing such communication and to a GDO that comprises means for 1-way, or preferably 2-way, communication between a vehicle and the GDO, and/or the GDO and a home.

### SUMMARY OF THE INVENTION

Safety is becoming an increasingly important issue, and therefore, methods and systems for improving safety are desirable. The system of the present invention includes a first communication module and a second communication module for communicating with one another. The first communication module is preferably located inside a vehicle, and the second communication module is preferably located in a Garage Door Opener (GDO) and/or a home. A first information relating to status information of the vehicle is transmitted between the first and second communication modules. Alternatively or additionally, a second information relating to status information of the GDO and/or the home is transmitted between the first and second communication modules.

The method of the present invention includes a first communication module located inside a vehicle and a second communication module located in a GDO and/or a home. The method comprises the step of transmitting a first information relating to status information of the vehicle between the first and second communication modules. Alternatively or additionally, the method comprises the step of transmitting a second information relating to status information of the GDO and/or the home between the first and second communication modules. The inventive method allows 1-way, or preferably 2-way, communication between a vehicle, a GDO and/or a home and vice versa.

### BRIEF DESCRIPTION OF THE DRAWING

FIG. 1 schematically illustrates an inventive communication system comprising the first communication module and the second communication module.

### DETAILED DESCRIPTION OF THE EXEMPLARY EMBODIMENT

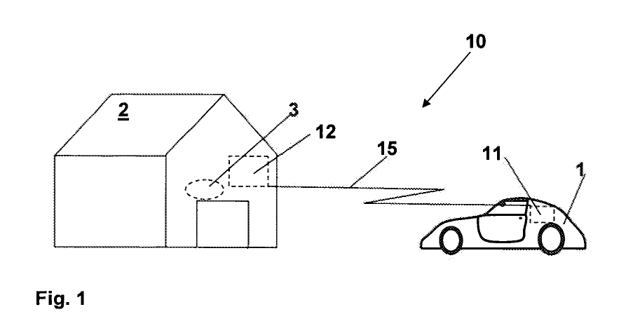

In FIG. 1, a communication system 10 according to the present invention is schematically shown. The communication system 10 comprises a first communication module 11 and a second communication module 12. The first and second communication modules 11, 12 communicate with one another by means of a wireless communication interface, or a wireless communication link, 15. The wireless communication interface 15 of the communication system 10 may comprise HomeLink™ technology, which is a product of Johnson Controls, Inc. However, it should be appreciated that other wireless systems could alternatively be used. The communication between the first module 11 and the second module 12 is either performed in a unidirectional manner or in a bidirectional manner. A bidirectional communication between the first and second communication modules 11, 12 is preferred according to the present invention.

The first communication module 11 is preferably located inside a vehicle 1. The second communication module 12 is preferably located in or assigned to a Garage Door Opener 3 (hereinafter also designated by GDO). Alternatively or additionally, the second communication module 12 could be located in or assigned to a home 2. The home 2 can be any house, apartment, office or the like. The GDO 3 and/or the home 2 could either be connected to a landline (wire bound) or wirelessly connected to the second communication module 12.

Due to the 1-way, or preferably 2-way, communication, it is possible to exchange information and/or commands between the vehicle 1, the GOP 3 and/or the home 3 by means of the inventive communication system and vice versa. The communication between the vehicle 1 and the GDO/home 2, 3 is preferably a wireless communication over the communication link 15. The communication between the GDO 3 and the home 2 can be provided wirelessly and/or by a landline (wire bound).

The GDO 3 according to the present invention is any means to open a garage door and/or a gate. For example, one possible GDO 3 is the commercially available Chamberlain GDO system. However, it should be appreciated that other GDO systems could be employed.

The vehicle 1 could be any vehicle known to a person skilled in the art. The vehicle 1 comprises means, e.g. the first communication module 12, that allow the 1-way, or preferably 2-way, communication with the GDO 3 and/or the home 2 system.

In one exemplary embodiment of the present invention, the vehicle 1 communicates to a home network/home module via the GDO 3 that a vehicle 1 has arrived. This is accomplished by the first communication module 11 transmitting a first information to the second communication module 12. In the exemplary embodiment, the first information is transmitted in response to GPS/location data, in response to the activation of a home GDO 3 and/or upon activation of the HomeLink™ system. Due to a vehicle identification and/or a homelink-identification, a device in the home preferably announces which vehicle 1 has arrived. Each vehicle 1 could have a unique tone, voice announcement and/or visual indicator, etc.

In the exemplary embodiment, the vehicle 1 comprises an alarm system, e.g. a horn and lights and/or other signaling means for generating acoustical and/or optical signals. The second information is a status information of the GDO 3 and/or the home 2, preferably an information to activate the alarm system of the vehicle 1. Due to the 1-way, or preferably 2-way, communication, the vehicle 1 is preferably used as a supplement to the home alarm system of the home 2. In case of an emergency, a communication is automatically or manually sent to the vehicle 1 to turn on the vehicle alarm system, i.e. especially the horn and/or the lights of the vehicle 1.

Preferably, the vehicle 1 also comprises a telematic means, preferably E911-Telematics. E911 is a North American telecommunications based system that automatically associates a physical address with the calling party's telephone number, and routes the call to the most appropriate Public Safety Answering Point (PSAP) for that address. The caller's address and information is displayed to the PSAP calltaker immediately upon call arrival. This provides emergency responders with the location of the emergency without the person calling for help having to provide it.

In case of an emergency in the home 2, the vehicle 1 the first communication module 11 receives from the second communication module 12 the second information. The second information could be a signal that an emergency call should be made or another notification channel, e.g. through a telematics unit, should be used to inform a call center (such as a PSAP), a vehicle owner or any other desired person that the vehicle alarm is activated and that the alarm was activated by the home network/home security system.

In yet another preferred embodiment of the present invention, the vehicle and/or GDO status information are communicated to a home network/home module. Vehicle status information can be any information that is measured, including for example, position data of the vehicle and/or any information about the status of the electric drives in the vehicle. The home device preferably relays all or a selected portion of the status to a consumer, e.g. the home- and/or vehicle owner. The home device could relay the status to the consumer via a text message to a phone, preferably a mobile phone, using text message/voice prompts or other means. Alternatively, the home device could relay the status to the consumer via email or other means. A unique ring tone is preferably established on the consumer's phone to suggest that the home device is calling.

Within the vehicle 1, announcements of GDO/home network status information are preferably communicated to the occupants of the vehicle 1 through displays and/or voice messages played to the vehicle occupant through an audio output system in the vehicle 1. Preferably, all of the status information could be announced or a selected portion could be announced. An important announcement is, for example, that the GDO 3 is closing. The information is preferably stored in the vehicle 1 and can be reviewed upon a vehicle occupant's choice.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A communication system (10) comprising a first communication module (11) and a second communication module (12), wherein the first communication module (11) is located inside a vehicle (1) and wherein the second communication module (12) is located in a Garage Door Opener (3) and/or a home (2), wherein a first information is transmitted wirelessly between the first and second communication modules (11, 12), the first information relating to status information of the vehicle (1), and/or wherein a second information is transmitted between the first and second communication modules (11, 12), the second information relating to status information of the Garage Door Opener (3) and/or the home (2).

2. A communication system (10) according to claim 1, wherein the first information is a measured value, preferably a position data of the vehicle (1) and/or any information about the status of electric drives in the vehicle (1).

3. A communication system (10) according to claim 1, wherein the vehicle (1) comprises an alarm system and wherein the second information is an information to activate the alarm system of the vehicle (1).

4. A communication method of a first communication module (11) and a second communication module (12), wherein the first communication module (11) is located inside a vehicle (1) and wherein the second communication module (12) is located in a Garage Door Opener (3) and/or a home (2), wherein the method comprises the step of transmitting a first information between the first and second communication modules (11, 12), the first information relating to status information of the vehicle (1), and/or wherein the method comprises the step of transmitting a second information between the first and second communication modules (11, 12), the second information relating to status information of the Garage Door Opener (3) and/or of the home (2).

5. A communication method according to claim 4, wherein the first information is a measured value, preferably a position data of the vehicle (1) and/or any information about the status of electric drives in the vehicle (1).

6. A communication method according to claim 4, wherein the vehicle (1) comprises an alarm system and wherein the second information is an information to activate the alarm system of the vehicle (1).
